(19) United States
(12) Patent Application Publication
(10) Pub. No.: US 2026/0048774 A1
(43) Pub. Date: Feb. 19, 2026

(54) STORAGE PLATFORM AND MOBILE WORKSTATION

(71) Applicant: TILTA INC., Burbank, CA (US)

(72) Inventors: Sen WU, Shenzhen (CN); Weihan SHE, Shenzhen (CN); Wenping ZENG, Shenzhen (CN); Kefeng ZHOU, Shenzhen (CN)

(21) Appl. No.: 19/299,674

(22) Filed: Aug. 14, 2025

(30) Foreign Application Priority Data
Aug. 16, 2024 (CN) 202421999574X

(51) Int. Cl. B62B 3/02

(52) U.S. Cl. CPC B62B 3/02; B62B 2205/20

(57) ABSTRACT

The present disclosure discloses a storage platform and a mobile workstation, including a first component and a second component. The second component is movably connected to the first component and includes a locking assembly. The locking assembly includes a trigger and a lock body, wherein the trigger is movably disposed on the second component and is operatively coupled to the lock body. The trigger is configured to drive the lock body to move, thereby unlocking it from the first component. The storage platform of the present disclosure enables the storage main body to be conveniently converted into a work surface for user operation.

### CROSS-REFERENCE TO RELATED APPLICATIONS

The present application for patent claims priority to and the benefit of pending Chinese Application on No. 202421999574X, filed on Aug. 16, 2024, and hereby expressly incorporated by reference herein as if fully set forth below in its entirety and for all applicable purposes.

### TECHNICAL FIELD

The present disclosure pertains to the field of expansion accessories, more particularly to a storage platform and a mobile workstation.

### INTRODUCTION

In daily life, a mobile workstation serves as an auxiliary vehicle, typically designed for work or outdoor activities. For instance, users can load photographic accessories onto the mobile workstation in various scenarios.

Conventional mobile workstations generally include multiple storage platforms connected by support columns, with wheels installed at the bottom storage platform for mobility. A conventional storage platform typically includes a base plate and baffle plates surrounding the base plate, creating a storage space for storing items. However, when a user intends to use the storage platform as an operable work platform, the baffle plates on the base plate can obstruct the user's hands, adversely affecting the usability of the storage platform as a work surface.

### BRIEF SUMMARY

Aspects of the present disclosure provide a storage platform and a mobile workstation, aiming to address the technical issue in the prior art where baffle plates hinder user operation when converting the storage platform into a work platform.

Some aspects of the present disclosure provide:

A storage platform, including:
a first component;
a second component movably connected to the first component, wherein the second component includes a locking assembly. The locking assembly includes a trigger and a lock body, with the trigger being movably disposed on the second component and operatively coupled to the lock body. The trigger is configured to drive the lock body to move, thereby unlocking it from the first component; wherein the first component and the second component are respectively one of a baffle member and a storage main body.

The present disclosure further provides a mobile workstation, including mobile wheels, support columns, and a plurality of the aforementioned storage platforms, wherein the first component includes the storage main body, and the second component includes the baffle member. Multiple storage main bodies are stacked on the support columns, and the mobile wheels are disposed on the side of the bottom storage main body facing away from an adjacent storage main body.

In the present disclosure, the user can actuate the trigger to move, thereby driving the lock body to disengage from the first component and unlock the first and second components. Since the first and second components are movably connected, the unlocked second component can rotate relative to the first component. As the storage main body is mounted on the support column, the baffle member can rotate relative to the storage main body, leaving at least one side of the storage main body unobstructed. This allows the user to place their hands freely on the work surface, facilitating operation. For example, the user can place electronic devices such as computers or notebooks on the support surface of the storage main body and stand or sit beside the unobstructed side, effectively converting the storage main body into a worktable.

### BRIEF DESCRIPTION OF THE DRAWINGS

To further illustrate the technical solutions in the embodiments or prior art, the following provides a brief description of the accompanying drawings for implementing exemplary embodiments of the present disclosure. Notably, the drawings represent only exemplary embodiments, and other derived configurations may be obtained by those skilled in the art without inventive effort.

FIG. 1 is a schematic diagram of a mobile workstation according to some aspects of the present disclosure.

FIG. 2 is an exploded diagram of a baffle member and a locking assembly according to some aspects of the present disclosure.

FIG. 3 is a diagram illustrating a mounting base and the locking assembly according to some aspects of the present disclosure.

FIG. 4 is a schematic diagram of a storage platform according to some aspects of the present disclosure.

FIG. 5 is an enlarged view of region A in FIG. 4.

FIG. 6 is another schematic diagram of the storage platform according to some aspects of the present disclosure.

FIG. 7 is an enlarged view of region B in FIG. 6.

### REFERENCE NUMERALS

100. mobile workstation; 10. storage platform; 20. support column; 201. clamping
buckle; 202. pipe clamp; 2011. locking portion; 2012. locking wrench; 60. movable wheel;
1. storage main body; 11. limit port; 12. support surface; 13. base plate; 14. locking strip; 15. mounting hole;
2. baffle member; 21. baffle plate; 22. mounting base; 221. first opening; 222. second opening; 223. first slide groove; 224. second slide groove; 225. first elastic component; 226. second elastic component;
3. locking assembly; 31. trigger; 311. trigger portion; 3111. stop protrusion; 312. trigger protrusion; 32. lock body; 321. locking pin; 322. inclined mobile groove; 3221. first inclined surface; 3222. second inclined surface.

The objectives, functional features, and aspects of the present disclosure will be further explained with reference to the exemplary embodiments and accompanying drawings.

### DETAILED DESCRIPTION

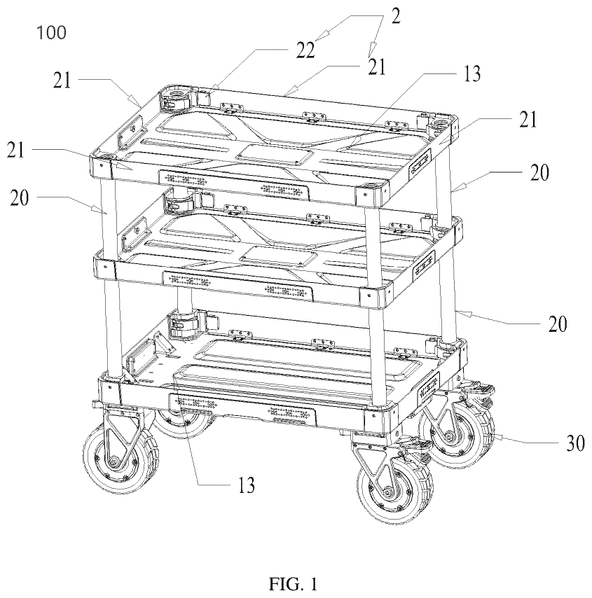

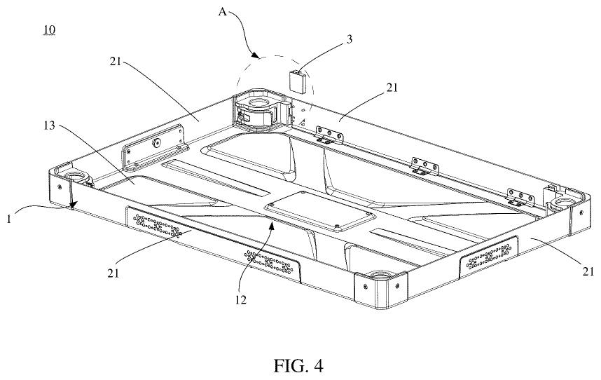

Referring to FIGS. 1 and 4, the present disclosure provides a portable mobile workstation 100, which may serve as a photography equipment cart. The mobile workstation includes support columns 20, mobile wheels 30, and multiple storage platforms 10. Each storage platform 10 includes a storage main body 1 and a baffle member 2, wherein the baffle member 2 can be locked to the storage main body 1 via a locking assembly 3. Each storage main body 1 includes a base plate 13 and three baffle plates 21, with multiple base plates 13 stacked on the support columns 20.

The support columns 20 are detachably mounted on the storage platform 10 via clamping buckles 201, while each storage platform 10 is detachably mounted on the support columns 20 in a stacked arrangement via clamping buckles 201

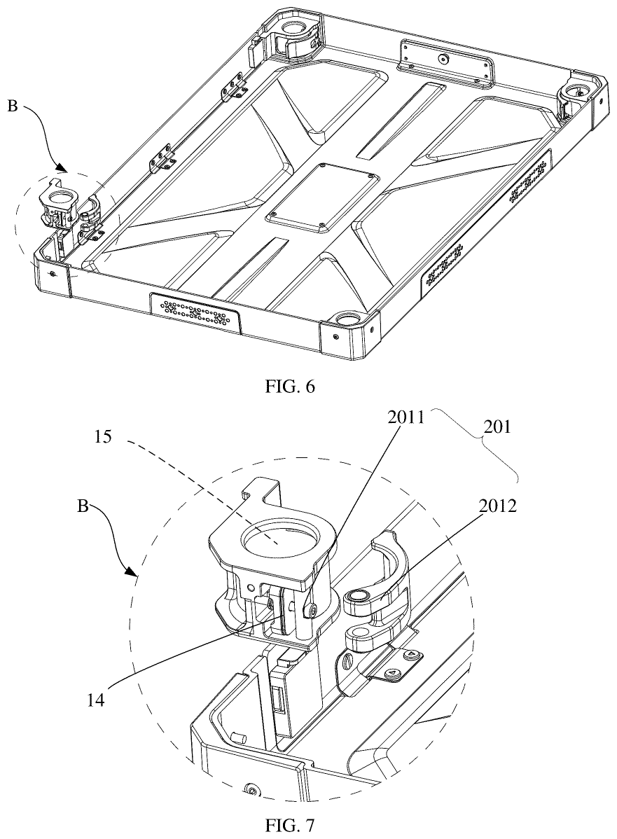

Referring to FIGS. 6-7, each storage platform 10 can be equipped with a clamping buckles 201. The storage platform 10 is provided with one or more mounting holes 15 configured for mounting the support columns 20. The storage platform 10 is connected with a locking strip 14. The clamping buckle 201 includes a locking portion 2011 and a locking wrench 2012, When the locking wrench 2012 is tightened, its locking head presses against the locking strip 14, enabling the locking strip 14 to move and clamp the support column 20 within the mounting hole 15, thereby completing the locked installation between the support column 20 and the storage platform 10.

In some aspects, a mobile workstations can include multi-tiered storage platforms 10 connected by support columns 20, with wheels installed at the bottom storage platform 10 to enable mobility. Each storage platform 10 can include a base plate 13 and surrounding baffle plates 21, forming a storage space for item placement. However, when a user attempts to use the storage platform 10 as an operable work platform, the baffle plates 21 can obstruct the user's hands.

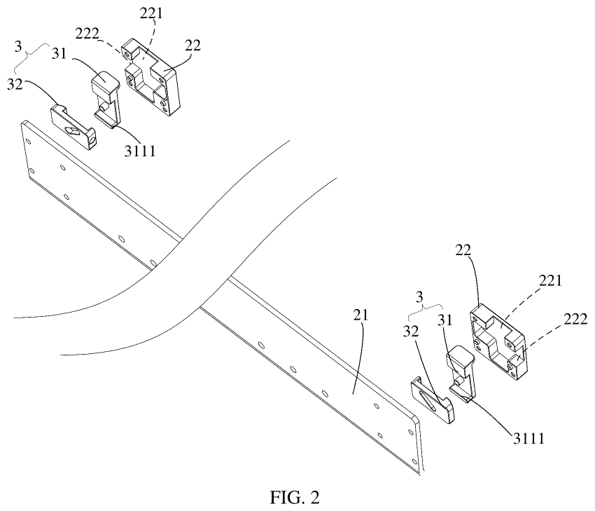

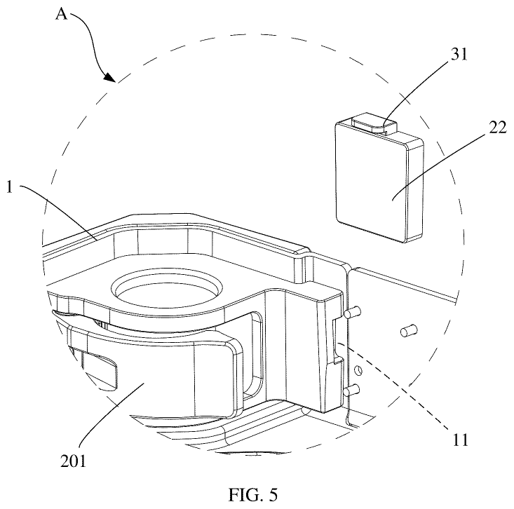

To address this, referring to FIGS. 2-5, the present disclosure provides a storage platform 10, including a first component having a limit port 11, a second component movably connected to the first component, and the second component includes a locking assembly 3. The locking assembly 3 includes a trigger 31 and a lock body 32, with the trigger 31 movably disposed on the second component and operatively coupled to the lock body 32. The trigger 31 is configured to drive the lock body 32 to disengage from the first component.

In some aspects, the first component may be the storage main body 1, and the second component may be the baffle member 2, with the locking assembly 3 mounted on the baffle member 2. Alternatively, the first component may be the baffle member 2, and the second component may be the storage main body 1, with the locking assembly 3 mounted on the storage main body 1. In both configurations, the storage main body 1 is mounted on the support columns 20.

In some aspects, the user can actuate the trigger 31 to move, thereby driving the lock body 32 to disengage from the first component and unlock the first and second components. Since the first and second components are movably connected, the unlocked second component can rotate relative to the first component. As the storage main body 1 is mounted on the support columns 20, the baffle member 2 can rotate relative to the storage main body 1, leaving at least one side of the storage main body 1 unobstructed. This enables the user to place their hands freely on the work surface, facilitating operation and access. For example, the user can place electronic devices such as computers or notebooks on the support surface 12 of the storage main body 1 and stand or sit beside the unobstructed side, effectively converting the storage main body 1 into a worktable.

In some aspects, when placing heavy objects on the support surface 12 of the storage main body 1, the baffle plates 21 would normally require the user to lift the object higher. In response, the locking assembly 3 enables the baffle member 2 to be lowered relative to the storage main body 1, reducing the effort needed to place heavy items on the storage main body 1.

In some aspects, the mobile workstation 100 may include multiple tiers of storage platforms 10, each equipped with a locking assembly 3 to enable independent adjustment of baffle members 2 on the tier of storage platform 10 for optimal workspace configuration.

In some aspects, the trigger 31 and the lock body 32 are engaged via inclined surfaces. For example, the trigger 31 includes a trigger portion 311 and a trigger protrusion 312. The first component is provided with a limit port 11. The lock body 32 includes a locking pin 321 and an inclined mobile groove 322 formed on the locking pin 321. The trigger protrusion 312 is accommodated within the inclined mobile groove 322. The trigger portion 311 can drive the trigger protrusion 312 to move, and the movement of the trigger protrusion 312 can abut against the wall of the inclined mobile groove 322, enabling the locking pin 321 to move to withdraw from the limit port 11. In some aspects, when the user presses the trigger portion 311, the trigger protrusion 312 moves along with the trigger portion 311. The trigger protrusion 312 can push against the wall of the inclined mobile groove 322 via the inclined surface, thereby driving the locking pin 321 to move to withdraw from the limit port 11, thus unlocking the first component and the second component.

After unlocking, the first component and the second component can rotate relative to each other, allowing the baffle member 2 to rotate relative to the storage main body 1. This configuration reduces interference from the baffle member 2 on one side of the storage main body 1, creating an open space. This configuration enables the user to convert the original storage platform 10 into a worktable on that side. It is worth noting that unlocking is intended to transform the storage platform 10 into a worktable, which may also retain storage functionality. Additionally, the user can revert the worktable back to its original state as a storage platform 10. For example, the user can rotate the baffle member 2 relative to the storage platform 10, press the trigger 31 to retract the locking pin 321, and release the trigger 31 once the baffle member 2 reaches a generally vertical position, allowing the locking pin 321 to extend into the limit port 11. This configuration re-engages the storage platform 10 and the baffle member 2. It should be understood that the limit port 11 may be a lock hole directly formed on the first component, or the first component may include a snap ring or hook with the limit port 11.

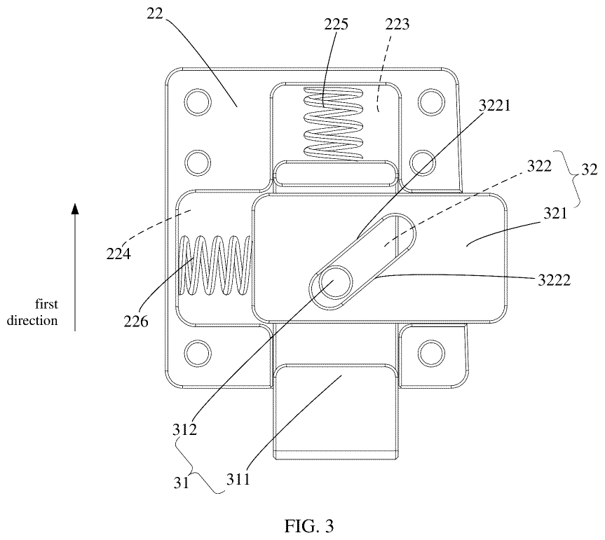

In some aspects, referring to FIG. 3, the inclined mobile groove 322 includes a first inclined surface 3221 and a second inclined surface 3222. Positioned between these two surfaces is the trigger protrusion 312. When the trigger portion 311 moves in a designated first direction, the trigger protrusion 312 abuts against the first inclined surface 3221, prompting the lock body 32 to move and retract from the limit port 11, thereby unlocking the storage main body 1 and the baffle member 2. Conversely, when the trigger portion 311 moves in a direction opposite to the first direction, the trigger protrusion 312 abuts against either the second inclined surface 3222 or the first inclined surface 3221, causing the lock body 32 to move and extend into the limit port 11, thus locking the storage main body 1 and the baffle member 2 together. For example, the first direction is indicated by the arrow in FIG. 3 and may vary depending on the viewing angle.

In some aspects, the end of the trigger portion 311 opposite the first opening 221 can be equipped with a stop protrusion 3111, which serves to restrict the movement of the lock body 32.

In some aspects, the second component includes a baffle plate 21 and a mounting base 22. The mounting base 22 is firmly attached to the baffle plate 21 and features a first opening 221 and a second opening 222. The trigger 31 is movably positioned on the mounting base 22, with a portion of its structure protruding outward through the first opening 221. Movement of the trigger 31 drives the lock body 32 to move, causing it to move relative to the second opening 222, enabling the lock body 32 to lock or unlock the storage main body 1. After unlocking, the second component can move relative to the first component. In this configuration, the mounting base 22 is affixed to the baffle plate 21, facilitating user operation during unlocking. When rotating the baffle plate 21, the user can simultaneously press the trigger 31 to retract the lock body 32 relative to the mounting base 22. Once the baffle plate 21 reaches a generally vertical position, the user can release the trigger 31, allowing the lock body 32 to engage with the storage main body 1.

In some aspects, mounting bases 22 are installed at both ends of the baffle plate 21, each equipped with a movable trigger 31 and a lock body 32. The triggers 31 at both ends of the baffle plate 21 can drive the lock bodies 32 at both ends to move towards each other, enabling the lock bodies 32 at both ends to unlock or lock with the corresponding ends of the storage main body 1. In this implementation, when unlocking is necessary, the user can press the triggers 31 with both hands, causing them to drive the lock bodies 32 to retract relative to the mounting bases 22, thereby unlocking both ends of the storage main body 1. At this point, the baffle plate 21 can be lowered relative to the storage main body 1, creating an open space on one side for user convenience. For locking, the user can press the triggers 31 with both hands and rotate the baffle plate 21 to a generally vertical position before releasing the triggers 31, allowing the lock bodies 32 to engage with the storage main body 1. In summary, this design simplifies the user's operation of the locking and unlocking processes of the storage platform 10. In some aspects, limit ports 11 can be provided at both ends of the storage main body 1 near the baffle plate 21. The triggers 31 at both ends of the baffle plate 21 can drive the lock bodies 32 to move towards each other, enabling the lock bodies 32 to withdraw from or extend into the limit ports 11, thereby unlocking or locking with the storage main body 1.

In some aspects, referring to FIG. 3, the mounting base 22 includes a first slide groove 223 and a second slide groove 224. The first slide groove 223 is connected to the first opening 221, and the second slide groove 224 is connected to the second opening 222. The trigger 31 is slidably positioned within the first slide groove 223, and the lock body 32 is slidably positioned within the second slide groove 224. This arrangement ensures that the walls of the first slide groove 223 restrict the movement of the trigger 31, while the walls of the second slide groove 224 restrict the movement of the lock body 32.

Referring to FIG. 3, a first elastic component 225 is placed between the trigger 31 and the wall of the first slide groove 223, and a second elastic component 226 is placed between the lock body 32 and the wall of the second slide groove 224. This setup allows the first elastic component 225 to provide elastic force for resetting the trigger 31, while the second elastic component 226 provides elastic force for resetting the lock body 32. On the other hand, in the locked state, the first and second elastic components 225 and 226 abut firmly against the trigger 31 and the lock body 32, respectively, enhancing their installation stability and improving the structural stability of the entire locking assembly 3. In some aspects, the clastic component can be a spring or the like.

What is claimed is:

1. A storage platform, comprising:
a first component; and
a second component movably connected to the first component, wherein the second component is provided with a locking assembly;
wherein the locking assembly comprises a trigger and a lock body;
wherein the trigger is movably provided on the second component, the trigger is configured to drive the lock body to move so as to unlock from the first component; and
wherein the first component are one of a baffle member and a storage main body, and the second component are another one of the baffle member and the storage main body.

2. The storage platform according to claim 1, wherein the trigger and the lock body are in inclined-surface engagement.

3. The storage platform according to claim 1, wherein the trigger comprises a trigger portion and a trigger protrusion;
wherein the first component is provided with a limit port;
wherein the lock body comprises a locking pin, and an inclined mobile groove is formed on the locking pin;
wherein the trigger protrusion is accommodated in the inclined mobile groove; wherein the trigger portion is configured to drive the trigger protrusion to move; and
wherein movement of the trigger protrusion is configured to abut against a groove wall of the inclined mobile groove, enabling the locking pin to be movable to withdraw from the limit port.

4. The storage platform according to claim 3, wherein the inclined mobile groove comprises a first inclined surface and a second inclined surface;
wherein the trigger protrusion is located between the first inclined surface and the second inclined surface;
wherein, in response to the trigger portion moving in a first direction, the trigger protrusion is configured to abut the first inclined surface to actuate the lock body to move so as to withdraw from the limit port; and
wherein, in response to the trigger portion moving in a direction opposite to the first direction, the trigger protrusion is configured to abut the second inclined surface or the first inclined surface, and the lock body is movable to extend into the limit port.

5. The storage platform according to claim 4, wherein an end of the trigger portion facing the first direction is provided with a stop protrusion, and the stop protrusion is configured to limit movement of the lock body.

6. The storage platform according to claim 1, wherein the first component comprises the storage main body, and the second component comprises the baffle member;
wherein the baffle member comprises a baffle plate and a mounting base;
wherein the mounting base is fixedly connected to the baffle plate, and the mounting base is provided with a first opening and a second opening;
wherein the trigger is movably provided on the mounting base with a portion thereof extending through the first opening outside the mounting base; and
wherein movement of the trigger drives the lock body to move relative to the second opening, enabling the lock body to lock or unlock with respect to the storage main body.

7. The storage platform according to claim 6, wherein the mounting base is provided with a first slide groove and a second slide groove;
wherein the first slide groove communicates with the first opening;
wherein the second slide groove communicates with the second opening;
wherein the trigger is slidably disposed in the first slide groove; and
wherein the lock body is slidably disposed in the second slide groove.

8. The storage platform according to claim 7, wherein the storage platform comprises a first elastic component that is disposed between the trigger and a groove wall of the first slide groove; and
wherein the storage platform comprises a second elastic component that is disposed between the lock body and a groove wall of the second slide groove.

9. The storage platform according to claim 6, wherein a plurality of mounting bases are installed at both ends of the baffle plate;
wherein each of the plurality of mounting bases is movably provided with the trigger and the lock body; and
wherein the triggers at both ends of the baffle plate drive the corresponding lock bodies at both ends to move toward each other, enabling the lock bodies at both ends to unlock or lock with respect to both ends of the storage main body, respectively.

10. A mobile workstation, comprising: mobile wheels, support columns, and multiple storage platforms according to claim 1, wherein the first component comprises the storage main body and the second component comprises the baffle member;
wherein multiple storage main bodies are stacked on the support columns; and
wherein the mobile wheels are disposed on a side of a bottom one of the multiple storage main bodies facing away from an adjacent storage main body.
